(19) United States
(12) Patent Application Publication
(10) Pub. No.: US 2014/0363757 A1
(43) Pub. Date: Dec. 11, 2014

(54) PRESSURE ADJUSTMENT UNIT AND REDOX DEVICE HAVING A PRESSURE ADJUSTMENT UNIT

(71) Applicant: Astrium GmbH, Taufkirchen (DE)

(72) Inventors: Walter JEHLE, Horgenzell (DE); Joachim LUCAS, Herdwangen-Schoenach (DE)

(73) Assignee: Astrium GmbH, Taufkirchen (DE)

(21) Appl. No.: 14/289,892

(22) Filed: May 29, 2014

(30) Foreign Application Priority Data
Jun. 11, 2013 (EP) 13171387.7

(51) Int. Cl. H01M 8/04

(52) U.S. Cl. CPC H01M 8/04104
USPC 429/515; 137/85

(57) ABSTRACT

A pressure adjustment unit for an adjustment of fluid pressures in at least one first fluid chamber and in at least one second fluid chamber, which at least in the main is separate from the first fluid chamber, within at least one pressure interval, in particular for an at least substantial avoidance of a relative overpressure in one of the fluid chambers, having at least one first pressure expansion element which is provided for modifying a spatial volume of the at least one first fluid chamber, having at least one second pressure expansion element which is provided for modifying a spatial volume of the at least one second fluid chamber, and having at least one pressure coupling unit which is provided for effecting a negative feedback of spatial volume changes of the at least one first fluid chamber and of the at least one second fluid chamber.

### PRIOR ART

The invention relates to a pressure adjustment unit according to the preamble of claim 1.

In the case of conventional pressure adjustment units in the prior art, which are provided for an adjustment of fluid pressures of fluids in various fluid chambers which in the main are separate from each other, actively controlled valves, in particular drain valves, are used in order to achieve an adjustment of the fluid pressures. In particular, in the case of a build-up of an overpressure in one of the fluid chambers fluid is drained from the fluid chamber in which the overpressure is formed. Alternatively, blow-out valves can drain fluid in the case of a limiting pressure in one of the fluid chambers being exceeded. A pressure adjustment by means of the conventional pressure adjustment units brings about a mass loss and, moreover, in most cases requires an active pressure monitoring in the fluid chambers. For closed systems, in which a replacement of mass losses of fluids is not provided, such pressure adjustment units cannot be used.

The objective of the invention is in particular to provide a pressure adjustment unit with a mass loss-free realization of a pressure adjustment. It is also an objective of the invention to provide a passive pressure adjustment unit which undertakes a pressure adjustment without active pressure measurement and activation of pressure expansion elements. The objective is achieved according to the invention by the features of patent claim 1, whereas advantageous embodiments and developments of the invention can be gathered from the dependent claims.

### Advantages of the Invention

Proposed is a pressure adjustment unit for an adjustment of fluid pressures in at least one first fluid chamber and in at least one second fluid chamber, which at least in the main is separate from the first fluid chamber, within at least one pressure interval, in particular for an at least substantial avoidance of a relative overpressure in one of the fluid chambers, having at least one first pressure expansion element which is provided for modifying a spatial volume of the at least one first fluid chamber, having at least one second pressure expansion element which is provided for modifying a spatial volume the at least one second fluid chamber, and having at least one pressure coupling unit which is provided for effecting a negative feedback of spatial volume changes of the at least one first fluid chamber and of the at least one second fluid chamber.

To be understood by a “pressure adjustment unit”, is in particular a unit which is provided for adjusting fluid pressures in at least one first fluid chamber and in at least one second fluid chamber, which at least in the main is separate from the first fluid chamber, and, in the case of an increase of a fluid pressure of the fluid in the at least one first fluid chamber or in the at least one second fluid chamber in relation to the at least one second fluid chamber or in relation to the at least one first fluid chamber, is in particular provided for lowering the spatial pressure in the first fluid chamber or in the at least one second fluid chamber and/or for increasing the spatial pressure in the at least one second fluid chamber or in the at least one first fluid chamber. In principle, the pressure adjustment unit for an adjustment of the fluid pressure can achieve a change of a fluid quantity in a constant spatial volume of the at least one first fluid chamber and/or of the at least one second fluid chamber, or can achieve a change of a spatial volume of the at least one first fluid chamber and/or of the at least one second fluid chamber with a constant fluid quantity. To be understood by a “fluid” is in particular a gas or a liquid. To be understood by a “fluid chamber” is in particular a space which is provided for receiving a gas and/or a liquid. Preferably, the first fluid chamber and second fluid chamber are filled with different gases and/or liquids. To be understood by “fluid chambers which at least in the main are separate from each other” is in particular that a first fluid chamber and a second fluid chamber are totally separated from each other fluidically or via a connecting element, which at least reduces a fluid flow and therefore at least slows down a pressure compensation, for example via an electrolyte-filled membrane between two fluid chambers, formed as gas chambers, in and/or on which a reaction between gases from the first fluid chamber and from the second fluid chamber takes place, wherein a gas flow into and through the membrane is possible and a large gas flow through the membrane from one gas chamber to the other gas chamber leads to a displacement and/or washing out of an electrolyte from the membrane.

To be understood by an “adjustment of fluid pressures within at least one pressure interval” is in particular that an adjustment of fluid pressures within a predetermined range takes place and in particular that after a maximum fluid pressure or a maximum fluid pressure difference has been exceeded an adjustment of the fluid pressures can no longer be achieved by means of the pressure adjustment unit, for example on account of achieving a maximum expansion of a spatial volume of a fluid chamber. To be understood by a “relative overpressure” is in particular a pressure difference between fluid pressures of two fluid chambers, in particular between fluid pressures of two at least basically separate fluid chambers. To be understood by an “at least substantial avoidance of a relative overpressure” is in particular that a relative overpressure which develops is adjusted by means of the pressure adjustment unit within at most four seconds, advantageously within at most two seconds and preferably within at most one second, and the pressure difference is reduced. To be understood by a “pressure expansion element” is in particular an element which at least partially delimits a fluid chamber and which in the case of an increase of a fluid pressure of the fluid chamber is at least displaced and/or deformed by expansion so that a spatial volume of the fluid chamber is increased, and in the case of a pressure exertion upon a side of the spatial volume of the fluid chamber facing away from the fluid chamber is reduced. The pressure expansion element is in particular embodied as a displaceable piston, as an expandable and compressible casing or as a deformable bellows. To be understood by a “pressure coupling unit” is in particular a unit which transmits a pressure—which acts upon the first pressure expansion element, in particular a fluid pressure in the first fluid chamber—to the second pressure expansion element, wherein the pressure is preferably transmitted with an opposite direction of action. For this, the pressure coupling unit in particular has a transmission element, for example a pressure piston or a passage filled with a pressure transmission fluid, wherein the pressure transmission fluid is adjacent to the first pressure expansion element and to the second pressure expansion element. In particular, the pressure coupling unit, without additional actuation by means of a control unit, automatically effects a transmission of pressures from the first pressure expansion element to the second pressure expansion element and vice versa and is therefore of a passive design. A simple and constructionally inexpensive passive pressure adjustment can in particular be achieved.

In a development of the invention, it is proposed that the pressure coupling unit comprises at least one pressure transmission fluid, in particular water. To be understood by a “pressure transmission fluid” is in particular a liquid which fills at least one passage which extends between the first pressure expansion element and the second pressure expansion element, and which on account of incompressibility transmits by means of the first pressure expansion element or the second pressure expansion element a pressure acting on them to the second pressure expansion element or to the first pressure expansion element. A pressure coupling unit which is inexpensive with regard to construction engineering can in particular be achieved.

Alternatively, it is proposed that the pressure coupling unit comprises a common wall of the first pressure expansion element and of the second pressure expansion element. It can in particular transmit a pressure directly and a particularly simply constructed pressure coupling unit can be achieved.

It is furthermore proposed that the at least one first pressure expansion element and the at least one second pressure expansion element are embodied as metal concertina-type bellows. To be understood by a “metal concertina-type bellows” is in particular a bellows produced from a metal and which has an interior cavity for receiving a fluid and which is enclosed by an expandable metal casing. In particular, the expandable metal casing is produced from overlapping elements which are displaceable in relation to each other and in the case of an increase of an internal pressure are displaced in relation to each other and therefore allow an expansion of the interior cavity. The metal concertina-type bellows are preferably produced from high-grade steel. In particular, the metal concertina-type bellows have spring constants between five hundred newtons per meter and ten thousand newtons per meter, wherein metal concertina-type bellows are selected with suitable spring constants in dependence upon the fluids in the fluid chambers. A pressure expansion element, in which additional sealing elements can be dispensed with and which can also be used during filling of the fluid chambers with fluids at high temperatures, can in particular be achieved.

It is furthermore proposed that the pressure adjustment unit comprises at least one third pressure expansion element which, via the pressure coupling unit, is coupled to the first pressure expansion element and to the second pressure expansion element. A pressure adjustment of at least three fluid chambers can in particular be achieved with reduced equipment cost.

Also proposed is a redox device, in particular a hydrogen-oxygen redox device, having at least one redox unit which is provided for carrying out at least one redox reaction, consuming and/or producing a first gas, in particular hydrogen gas, and/or a second gas, in particular oxygen gas, having at least one first gas chamber for the first gas and at least one second gas chamber for the second gas, and having a pressure adjustment unit according to one of claims 1 to 5 for an adjustment of a fluid pressure of the first gas chamber and of the second gas chamber. To be understood by a “redox device” is in particular a device having at least one redox unit. To be understood by a “redox unit” is a unit having at least two electrodes—of which one is preferably embodied as a hydrogen electrode and one preferably embodied as an oxygen electrode—a current circuit connecting the two electrodes, at least one electrolyte arranged at least between the two electrodes, and/or an electrolyte-filled or ion-conducting membrane arranged at least between the two electrodes, wherein by means of the unit a redox reaction is carried out, during which—with release of energy in the form of electric power which is released via the electric circuit—the first gas is oxidized and the second gas is reduced and in a reaction are converted to form a product substance, preferably water, and in a reaction which is delivered to an environment or to a storage tank, or during which—with expenditure of energy in the form of electric power—an educt substance, preferably water, is decomposed to produce a first gas, preferably molecular hydrogen, and a second gas, preferably molecular oxygen, and the first gas and the second gas are discharged to the environment or into storage tanks. The redox unit is in particular embodied as a fuel cell in which—with release of energy by means of current generation—molecular hydrogen, preferably in the form of hydrogen gas, and molecular oxygen, preferably in the form of oxygen gas, react to form water, and/or as an electrolyzer for hydrogen and oxygen, in which—with absorption of energy by means of an electric current—water is decomposed into molecular oxygen and molecular hydrogen. In principle, instead of water as a product substance or educt substance another chemical substance which contains hydrogen atoms and oxygen atoms can be used. For example, the redox unit, instead of being embodied as a hydrogen-oxygen redox unit, can be embodied as a redox unit for other substances which converts the other substances in a redox reaction similar to the redox reaction of the hydrogen-oxygen redox unit, for example as a carbon monoxide-oxygen redox unit which converts carbon monoxide and oxygen gas to form carbon dioxide or decomposes carbon dioxide into carbon monoxide and oxygen gas. The redox unit is in particular embodied as a high-pressure redox unit which is operated with an internal pressure in gas chambers of at least sixty bar, advantageously at least eighty bar and preferably at least a hundred bar. To be understood by “redox reaction” is in particular a reaction in which at least two chemical substances react with each other, wherein at least one chemical substance releases electrons and is therefore oxidized, and at least one chemical substance absorbs electrons and is therefore reduced. To be understood by “hydrogen gas” is in particular hydrogen in molecular form which exists as gas. To be understood by “oxygen gas” is in particular oxygen in molecular form which exists as gas. To be understood by an “electrolyte” is in particular an ion-conducting substance, preferably in the form of a solution, for example an alkaline solution. During a startup of the redox device a build-up of a relative overpressure and damage to the membrane can in particular be avoided.

It is also proposed that the pressure adjustment unit has at least one third pressure expansion element which is provided for modifying a spatial volume of a third fluid chamber. A pressure adjustment of pressures in fluid chambers for two educts or products and for one product or educt can in particular be achieved.

It is furthermore proposed that the redox device comprises at least one additional redox unit, which is materially coupled to the at least one redox unit. To be understood by “materially coupled” is in particular that product substances of the at least one redox unit are used as educt substances of the at least one additional redox unit and product substances of the at least one additional redox unit are used as educt substances of the one redox unit, and/or that the at least one redox unit and the at least one additional redox unit have a common educt supply and/or product supply and a flow of educt substances is conducted in a plurality of similarly embodied redox units. The at least one redox unit and the at least one additional redox unit are in particular embodied as a fuel cell-electrolyzer pair. Use of not fully converted educt substances can in particular be achieved or a regenerative fuel cell system can in particular be provided.

It is also proposed that the redox device comprises an additional pressure adjustment unit for an adjustment of fluid pressures of the at least one additional redox unit. A reliable adjustment of fluid pressures, in particular during a startup, of both redox units can in particular be achieved.

It is furthermore proposed that the at least one redox unit and the at least one additional redox unit are embodied as a regenerative fuel cell system. To be understood by “regenerative fuel cell system” is in particular that the redox device has at least one pair of a redox unit embodied as a fuel cell and of at least one redox unit which is coupled to the at least one fuel cell and embodied as an electrolyzer for hydrogen and oxygen, wherein during a charging process, to form an energy store in the regenerative fuel cell system by means of an applied external electric current, the at least one electrolyzer for hydrogen and oxygen decomposes water from a water supply into molecular hydrogen and molecular oxygen, wherein the molecular hydrogen and the molecular oxygen are discharged in each case into storage tanks, and in a discharging process, for an energy release via electric current, molecular hydrogen and molecular oxygen in the at least one fuel cell react to form water. The regenerative fuel cell system therefore fulfills a function of an accumulator. The regenerative fuel cell system can in particular be desed for a closed operation. To be understood by a “closed operation” is in particular an operation in which the regenerative fuel cell system is operated via a multiplicity of charging-discharging cycles without material exchange with an environment. To be understood by an “operation without material exchange with the environment” is in particular that the regenerative fuel cell system is equipped with an initial supply of water and/or molecular oxygen and/or molecular hydrogen in storage tanks, wherein via the multiplicity of charging-discharging cycles only the initial supply of water and/or molecular oxygen and/or molecular hydrogen is converted and replenishment of the initial supply does not take place. In particular, during an operation without material exchange with the environment an extraction from the storage tanks is not provided. A regenerative fuel cell system with high operating reliability can in particular be achieved.

Also proposed is a method for pressure regulation of a redox device according to the invention.

### DRAWINGS

Further advantages are gathered from the following drawing description. In the drawings, three exemplary embodiments of the invention are shown. The drawings, the description and the claims contain numerous features in combination. The person skilled in the art will expediently also take the features into consideration individually and group them to form meaningful further combinations.

In the drawing:

FIG. 1 shows a schematic representation of the functioning principle of a pressure adjustment unit according to the invention,

FIG. 2 shows a redox device with a redox unit and the pressure adjustment unit according to the invention,

FIG. 3 shows a redox device embodied as a regenerative fuel cell system with two pressure adjustment units according to the invention, and

FIG. 4 shows a schematic representation of an alternative pressure adjustment unit according to the invention.

### DESCRIPTION OF THE EXEMPLARY EMBODIMENTS

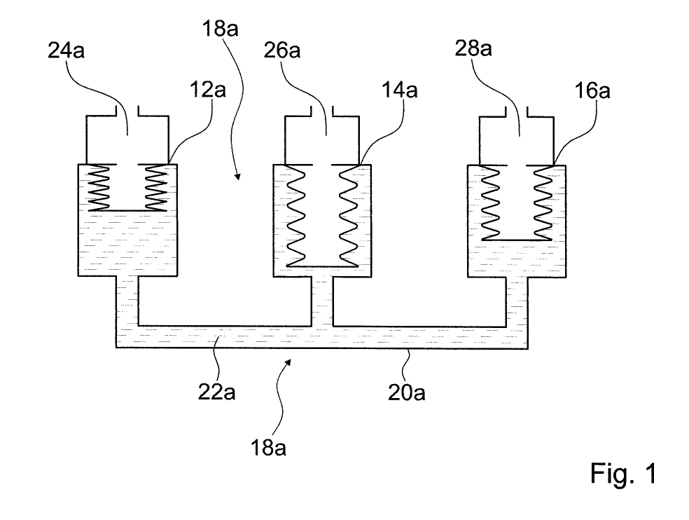

FIG. 1 shows a schematic representation of a pressure adjustment unit 10a according to the invention for an adjustment of fluid pressures in a first fluid chamber 24a and in at least one second fluid chamber 26a, which at least in the main is separate from the first fluid chamber 24a, within at least one pressure interval, in particular for an at least substantial avoidance of a relative overpressure in one of the fluid chambers 24a, 26a, having a first pressure expansion element 12a which is provided for modifying a spatial volume of the at least one first fluid chamber 24a, having a second pressure expansion element 14a which is provided for modifying a spatial volume of the at least one second fluid chamber 26a, and having at least one pressure coupling unit 18a which is provided for effecting a negative feedback of spatial volume changes of the at least one first fluid chamber 24a and of the at least one second fluid chamber 26a. For this, the pressure coupling unit 18a transmits an expansion of the pressure expansion element 12a inversely to the pressure expansion element 14a, and vice versa, so that in the case of an expansion of one of the pressure expansion elements 12a, 14a the other pressure expansion element 14a, 12a is compressed. For an transmission of the expansions of the pressure expansion elements 12a, 14a inversely to each other, and therefore of the fluid pressures, the pressure coupling unit 18a comprises a pressure transmission fluid 22a. The pressure transmission fluid 22a is in the form of water and fills a pressure transmission fluid passage 20a which encompasses the pressure expansion elements 12a, 14a. The first pressure expansion element 12a and the second pressure expansion element 14a are embodied as a metal concertina-type bellows made of high-grade steel having a cavity in each case which forms a part of the first fluid chamber 24a or of the second fluid chamber 26a. The first pressure expansion element 12a and the second pressure expansion element 14a have a spring constant of one thousand newtons per meter. The pressure expansion unit 10a also comprises a third pressure expansion element 16a which is coupled via the pressure coupling unit 18a to the first pressure expansion element 12a and to the second pressure expansion element 14a so that the pressure adjustment unit 10a balances fluid pressures of three fluid chambers 24a, 26a, 28a. The pressure adjustment unit 10a can adjust fluid pressure differences within a pressure interval which is provided by a maximum expansion of the pressure expansion elements 12a, 14a, 16a. If fluid pressure differences exceed a limiting value which leads to a maximum expansion of one of the pressure expansion elements 12a, 14a 16a being exceeded and so leads to rupturing of one of the pressure expansion elements 12a, 14a, 16a, then a pressure adjustment can therefore no longer be undertaken.

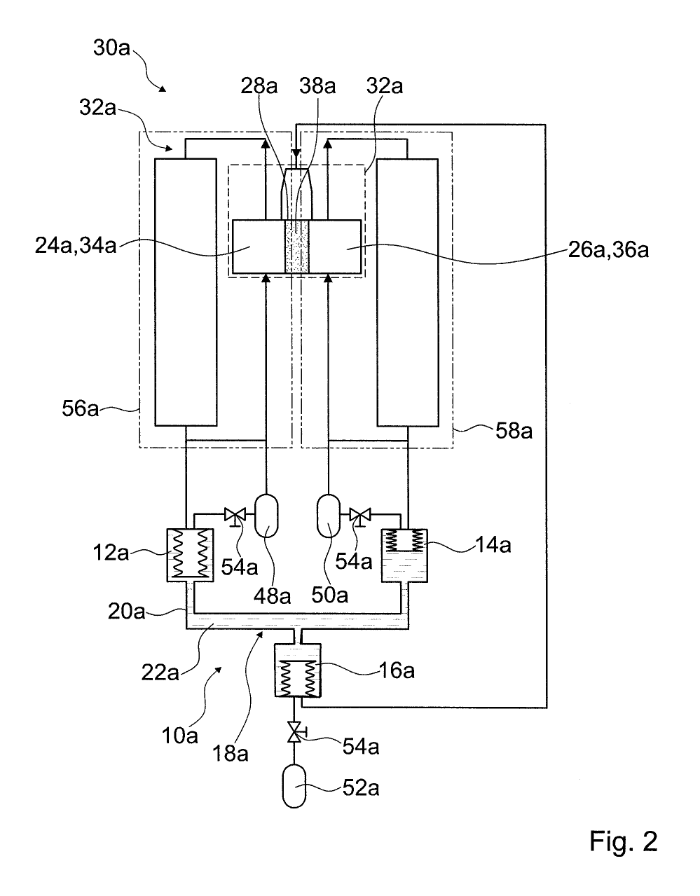

In one application of the pressure adjustment unit 10a according to the invention, this is used for an adjustment of fluid pressures of a redox device 30a (FIG. 2). The redox device 30a has a redox unit 32a which is provided for carrying out at least one redox reaction, producing a first gas in the form of hydrogen gas and a second gas in the form of oxygen gas, and in the process electrolytically decomposes an educt in the form of water, having a first gas chamber 34a for the first gas and having a second gas chamber 36a for the second gas, and has a pressure adjustment unit 10a according to the invention for an adjustment of a fluid pressure of the first gas chamber 34a and of the second gas chamber 36a, which functions according to the schematic functioning principle represented in FIG. 1. The redox unit 32a is therefore embodied as an electrolyzer for hydrogen gas and oxygen gas. The pressure expansion elements 12c, 14c are in the form of metal concertina-type bellows which are connected to gas sides of the redox unit 32a and therefore form a part of the first gas chamber 34a and of the second gas chamber 36a. The gas chambers 34a, 36a therefore form the fluid chambers 24a, 26a, the fluid pressures of which are adjusted by means of the pressure adjustment unit 10a. An adjustment of the fluid pressures of the fluid chambers 24a, 26a is in particular undertaken during a startup of the redox device 30a.

The first gas chamber 34a and the second gas chamber 36a of the redox unit 32a are separated from each other by means of an electrolyte-filled membrane 38a and are therefore in the main separate from each other. In particular, a direct gas exchange between the gas chambers 34a, 36a is not possible since the gases first of all have to pass through the membrane 38a, and in the case of a pressure increase in one of the gas chambers 34a, 36a electrolyte is displaced from the membrane 38a as a result of a developing pressure drop after a limiting pressure has been exceeded. The redox unit 32a is embodied as an alkaline high-pressure electrolyzer with a potassium hydroxide solution as electrolyte which is fixed in membrane 38a, and which is operated at gas pressures in a range of between eighty and a hundred bar and at an operating temperature in a temperature range of approximately eighty to two hundred degrees Celsius. In principle, the redox device 30a can also comprise a redox unit 32a which is designed for an operation at lower or higher fluid pressures or at lower or higher fluid pressures and/or which has an electrolyte which differs from potassium hydroxide. The electrolyte-filled membrane 38a is arranged between two electrodes. The redox unit 32a is supplied during operation with electric current by means of a direct current source, which is not shown, and by means of the electric current in reaction zones, which are formed by contact zones of the electrodes and of the electrolyte-filled membrane 38a, electrolytically decomposes water, which is fed to the membrane 38a from a liquid storage vessel 52a which is formed as a water storage tank, into molecular hydrogen and molecular oxygen. Molecular hydrogen and molecular oxygen are then pumped around in gas circuits 56a, 58a and stored in gas storage vessels 48a, 50a. In a non-operating state, the gas chambers 34a, 36a are filled with residual gas at a pressure of about one bar. During a startup of the redox unit 32a, a pressure rapidly increases in the gas chambers 34a, 36a. If the development of a pressure drop occurs in this case, for example on account of leakages on the gas side of the redox unit 32a, then after a limiting pressure difference has been exceeded the fixed electrolyte can be displaced from the membrane 38a, as a result of which the redox unit 32a is damaged. By means of the pressure adjustment unit 10a, in the case of a relative pressure increase in one of the gas chambers 34a, 36a in relation to the other of the gas chambers 34a, 36a, the pressure expansion element 12a, 14a, forming a part of the respective gas chamber 34a, 36a, is expanded, however, as a result of which a spatial volume of the respective gas chamber 34a, 36a is increased and therefore a fluid pressure of the respective gas chamber 34a, 36a is reduced. Via the pressure coupling unit 18a of the pressure adjustment unit 10a, a negative feedback of spatial volume changes of the respective gas chamber 34a, 36a with spatial volume changes of the respectively other gas chamber 36a, 34a is effected by a spatial volume increase of the respective gas chamber 34a, 36a exerting a pressure upon a pressure transmission fluid 22a, which is conducted in a pressure transmission fluid passage 20a of the pressure coupling unit 18a, which pressure transmission fluid, on account of incompressibility as liquid, exerts this pressure upon the pressure expansion element 14a, 12a of the respectively other gas chamber 36a, 34a and compresses this, as a result of which a spatial volume reduction and fluid pressure increase of the respectively other gas chamber 36a, 34a is effected. A build-up of an excessively large pressure difference between the gas chambers 34a, 36a is therefore avoided. The pressure expansion elements 12a, 14a are embodied as metal concertina-type bellows made of high-grade steel and have a spring constant of one thousand Newton per meter. Via relief valves 54a, in the case of a maximum fluid pressure in the pressure expansion elements 12a, 14a being exceeded, gas is released from the fluid chambers 24a, 26a into the gas storage vessels 48a, 50a in order to prevent damage to the pressure expansion elements 12a, 14a.

The pressure adjustment unit 10a has a third pressure expansion element 16a which is provided for modifying a spatial volume of a third fluid chamber 28a which is formed by a water-filled chamber of the redox unit 32a. The third pressure expansion element 16a is coupled via the pressure coupling unit 18a to the first pressure expansion element 12a and to the second pressure expansion element 14a. Via the third pressure expansion element 16a, when water is being fed to the membrane 38a during a startup of the redox unit 32a of the redox device 30a a fluid pressure in the gas chambers 34a, 36a is increased by means of the pressure adjustment unit 10a so that an operating pressure is achieved more rapidly than without the third pressure expansion element 16a. The third pressure expansion element 16a is constructed as a metal concertina-type bellows made of high-grade steel and has a spring constant of seven thousand newtons per meter.

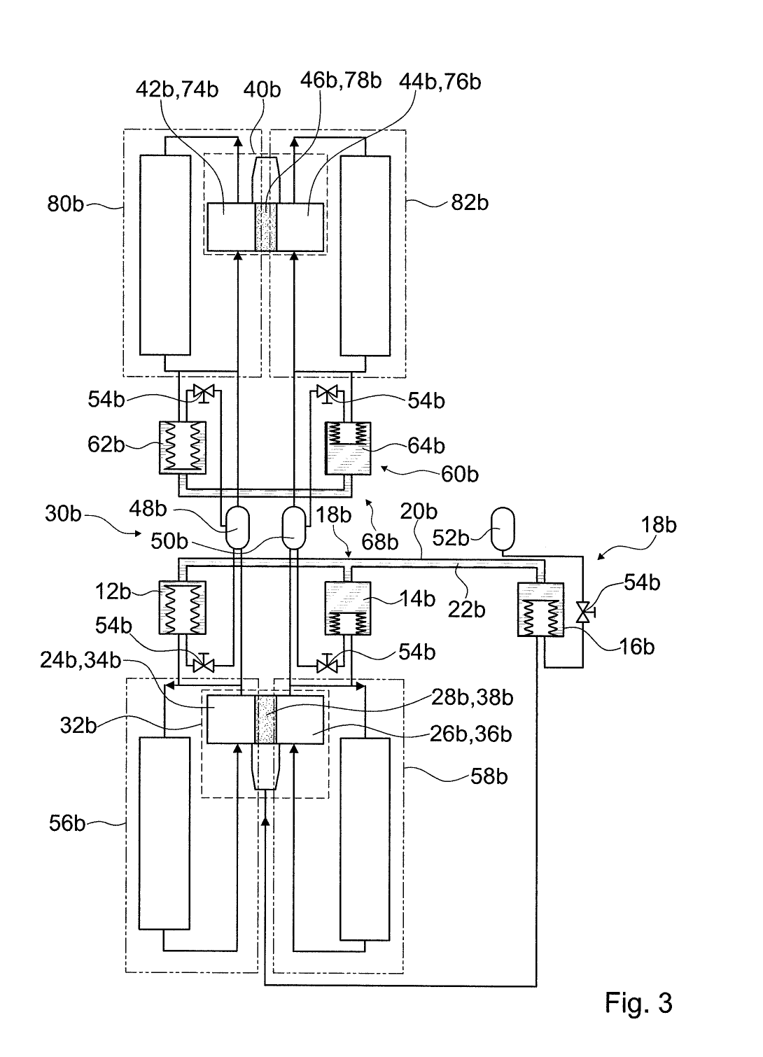

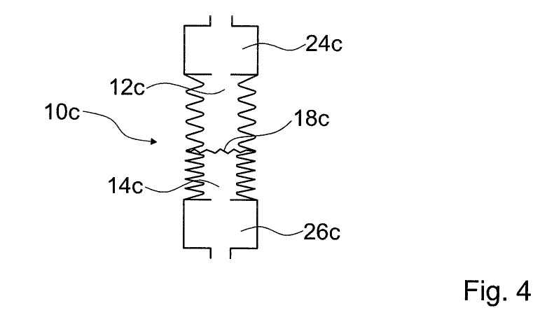

Shown in FIGS. 3 and 4 are two further exemplary embodiments of the invention. The subsequent descriptions and the drawings are basically limited to the differences between the exemplary embodiments, wherein with regard to similarly designated components, in particular with regard to components with the same designations, reference is basically also to be made to the drawings and/or to the description of the other exemplary embodiments, in particular of FIGS. 1 and 2. For differentiation between the exemplary embodiments, the letter a is placed after the designations of the exemplary embodiment in FIGS. 1 and 2. In the exemplary embodiments of FIGS. 3 and 4, the letter a is replaced by the letters b to c.

In an alternative embodiment of a redox device 30b—embodied as a hydrogen-oxygen redox device 30b, which has a redox unit 32b which is provided for carrying out at least one redox reaction, producing a first gas in the form of hydrogen gas and second gas in the form of oxygen gas, and in so doing electrolytically decomposes an educt in the form of water, having a first gas chamber 34b for the first gas and having a second gas chamber 36b for the second gas, and having a pressure adjustment unit 10b according to the invention for an adjustment of a fluid pressure of the first gas chamber 34b and of the second gas chamber 36b—the redox device 30b has an additional redox unit 40b having a first gas chamber 42b and a second gas chamber 44b which in the main are separated by means of an electrolyte-filled membrane 46b which is materially coupled to the at least one redox unit 32b. The membrane 46b is also filled with a potassium hydroxide solution as electrolyte with is fixed in a structure of the membrane 46b. The redox unit 32b and the additional redox unit 40b are embodied as a regenerative fuel cell system, wherein the redox unit 32b is embodied as a high-pressure electrolyzer and the additional redox unit 40b is embodied as a fuel cell. During a charging process of the regenerative fuel cell system to form an energy store, by means of an applied external electric current in the redox unit 32b, which is embodied as an electrolyzer for hydrogen and oxygen, water from a water supply in a liquid storage vessel 52b is decomposed into molecular hydrogen and molecular oxygen and the resulting molecular hydrogen and molecular oxygen are discharged in each case into gas storage vessels 48b, 50b, and during a discharging process of the regenerative fuel cell system, for an energy discharge via electric current, molecular hydrogen and molecular oxygen react in the additional redox unit 40b, which is embodied as a fuel cell, to form water.

The regenerative fuel cell system is designed for a closed operation in which the regenerative fuel cell system is operated via a multiplicity of charging-discharging cycles without material exchange with an environment. During an operation of the redox device 30b, the redox unit 32b and the additional redox unit 40b are operated alternately, wherein during a stationary phase of the redox unit 32b or of the additional redox unit 40b residual gases are also circulated in gas circuits 56b, 58b of the redox unit 32b and gas circuits 80b, 82b of the additional redox unit 40b in order to avoid an build-up of oxyhydrogen gas. In the gas circuits 56b, 58b, 80b, 82b, elements—not shown—are arranged in this case for dehumidification and foreign gas scrubbing of gas flows in the gas circuits 56b, 58b, 80b, 82b. The redox device 30b in this case has an additional pressure adjustment unit 60b for an adjustment of fluid pressures of the at least one additional redox unit 40b, wherein the additional pressure adjustment unit 60b and two pressure expansion elements 62b, 64b form parts of gas chambers 42b, 44b of the additional redox unit 40b and, in a way already described, by means of a pressure coupling unit 68b, which has a pressure transmission fluid 72b in a pressure transmission fluid passage 70b, adjust the fluid pressures in fluid chambers 74b, 76b, 78b formed by the gas chambers 42b, 44b of the additional redox unit 40b, in particular during a startup phase or a shutdown phase. The pressure expansion elements 62b, 64b are constructed as metal concertina-type bellows with a spring constant of one thousand newtons per. The redox unit 32b and the pressure adjustment unit 10b are embodied in a similar manner to the first exemplary embodiment.

FIG. 4 shows in a schematic representation a further alternative design of a pressure adjustment unit 10c according to the invention for an adjustment of fluid pressures in a first fluid chamber 24c and in at least one second fluid chamber 26c, which in the main is separate from the first fluid chamber 24c, within a pressure interval, in particular to avoid a relative overpressure in one of the fluid chambers 24c, 26c. The pressure adjustment unit 10c comprises a first pressure expansion element 12c which is provided for modifying a spatial volume of the first fluid chamber 24c, a second pressure expansion element 14c which is provided for modifying a spatial volume of the second fluid chamber 26c, and a pressure coupling unit 18c which is provided for effecting a negative feedback of spatial volume changes of the at least one first fluid chamber 24c and of the at least one second fluid chamber 26c. The pressure coupling unit 18c comprises a common wall of the first pressure expansion element 12c and of the second pressure expansion element 14c. The first pressure expansion element 12c and the second pressure expansion element 14c are formed in one piece with each other as metal concertina-type bellows made of high-grade steel with a common wall, wherein the common wall separates a cavity in the first pressure expansion element 12c and a cavity in the second pressure expansion element 14c from each other. A pressure increase in the first fluid chamber 24c effects an expansion of the first pressure expansion element 12c and displaces the common wall into the cavity of the second pressure expansion element 14c, as a result of which a spatial volume of the second pressure expansion element 14c is reduced and the spatial volume change of the first fluid chamber 24c is transmitted inversely to the second fluid chamber 26c. As a result of a reduction of the spatial volume of the second fluid chamber 26c, the fluid pressure in the second fluid chamber 26c is increased. An increase of the fluid pressure in the second fluid chamber 26c continues until by displacement of the common wall the fluid pressures in the first fluid chamber 24c and in the second fluid chamber 26c are balanced. By means of the pressure adjustment unit 10c, a build-up of a relative overpressure in one of the fluid chambers 24c, 26c is therefore rapidly counteracted.

### DESIGNATIONS

10 Pressure adjustment unit
12 Pressure expansion element
14 Pressure expansion element
16 Pressure expansion element
18 Pressure coupling unit
20 Pressure transmission fluid passage
22 Pressure transmission fluid
24 Fluid chamber
26 Fluid chamber
28 Fluid chamber
30 Redox device
32 Redox unit
34 Gas chamber
36 Gas chamber
38 Membrane
40 Redox unit
42 Gas chamber
44 Gas chamber
46 Membrane
48 Gas storage vessel
50 Gas storage vessel
52 Liquid storage vessel
54 Relief valve
56 Gas circuit
58 Gas circuit
60 Pressure adjustment unit
62 Pressure expansion element
64 Pressure expansion element
68 Pressure coupling unit
70 Pressure transmission fluid passage
72 Pressure transmission fluid
74 Fluid chamber
76 Fluid chamber
78 Fluid chamber
80 Gas circuit
82 Gas circuit

1. A pressure adjustment unit for an adjustment of fluid pressures in at least one first fluid chamber; and in at least one second fluid chamber, which, at least substantially, is separate from the first fluid chamber, within at least one pressure interval, in particular for an at least substantial avoidance of a relative overpressure in one of the fluid chambers,
the pressure adjustment unit comprising:
at least one first pressure expansion element which is provided for modifying a spatial volume of the at least one first fluid chamber;
at least one second pressure expansion element which is provided for modifying a spatial volume of the at least one second fluid chamber; and
at least one pressure coupling unit which is provided for effecting a negative feedback of spatial volume changes of the at least one first fluid chamber and of the at least one second fluid chamber.

2. The pressure adjustment unit according to claim 1,
wherein the pressure coupling unit comprises at least one pressure transmission fluid, in particular water.

3. The pressure adjustment unit according to claim 1,
wherein the pressure coupling unit comprises a common wall of the first pressure expansion element and of the second pressure expansion element.

4. The pressure adjustment unit according to claim 1,
wherein the at least one first pressure expansion element and the at least one second pressure expansion element are embodied as metal concertina-type bellows.

5. The pressure adjustment unit according to claim 1, further comprising:
at least one third pressure expansion element, which is coupled via the pressure coupling unit to the first pressure expansion element and to the second pressure expansion element.

6. A redox device, in particular a hydrogen-oxygen redox device, comprising:
at least one redox unit which is provided for carrying out at least one redox reaction, consuming and/or producing a first gas, in particular hydrogen gas, and/or a second gas, in particular oxygen gas;
at least one first gas chamber for the first gas;
at least one second gas chamber for the second gas; and
a pressure adjustment unit according to claim 1 for an adjustment of a fluid pressure of the first gas chamber and of the second gas chamber.

7. The redox device according to claim 6,
wherein the pressure adjustment unit has at least one third pressure expansion element which is provided for modifying a spatial volume of a third fluid chamber.

8. The redox device according to claim 6, further comprising:
at least one additional redox unit which is materially coupled to the at least one redox unit.

9. The redox device according to claim 8, further comprising:
an additional pressure adjustment unit for an adjustment of fluid pressures of the at least one additional redox unit.

10. The redox device according to claim 8,
wherein the at least one redox unit and the at least one additional pressure redox unit are embodied as a regenerative fuel cell system.

11. A method for pressure regulation of a redox device according to claim 6.

12. The pressure adjustment unit according to claim 2,
wherein the pressure coupling unit comprises a common wall of the first pressure expansion element and of the second pressure expansion element.

13. The pressure adjustment unit according to claim 2,
wherein the at least one first pressure expansion element and the at least one second pressure expansion element are embodied as metal concertina-type bellows.

14. The pressure adjustment unit according to claim 3,
wherein the at least one first pressure expansion element and the at least one second pressure expansion element are embodied as metal concertina-type bellows.

15. The pressure adjustment unit according to claim 2, further comprising:
at least one third pressure expansion element, which is coupled via the pressure coupling unit to the first pressure expansion element and to the second pressure expansion element.

16. The pressure adjustment unit according to claim 3, further comprising:
at least one third pressure expansion element, which is coupled via the pressure coupling unit to the first pressure expansion element and to the second pressure expansion element.

17. The pressure adjustment unit according to claim 4, further comprising:
at least one third pressure expansion element, which is coupled via the pressure coupling unit to the first pressure expansion element and to the second pressure expansion element.

18. A redox device, in particular a hydrogen-oxygen redox device, comprising:
at least one redox unit which is provided for carrying out at least one redox reaction, consuming and/or producing a first gas, in particular hydrogen gas, and/or a second gas, in particular oxygen gas;
at least one first gas chamber for the first gas;
at least one second gas chamber for the second gas; and
a pressure adjustment unit according to claim 2 for an adjustment of a fluid pressure of the first gas chamber and of the second gas chamber.

19. The redox device according to claim 7, further comprising:
at least one additional redox unit which is materially coupled to the at least one redox unit.

20. The redox device according to claim 9,
wherein the at least one redox unit and the at least one additional pressure redox unit are embodied as a regenerative fuel cell system.
